(19) United States
(12) Patent Application Publication
(10) Pub. No.: US 2013/0142950 A1
(43) Pub. Date: Jun. 6, 2013

(54) METHOD FOR PRODUCING A LAYER BY MEANS OF COLD SPRAYING AND USE OF SUCH A LAYER

(71) Applicants: Axel Arndt, Berlin (DE); Christian Doye, Berlin (DE); Oliver Stier, Berlin (DE); Raymond Ullrich, Schonwalde (DE)

(72) Inventors: Axel Arndt, Berlin (DE); Christian Doye, Berlin (DE); Oliver Stier, Berlin (DE); Raymond Ullrich, Schonwalde (DE)

(21) Appl. No.: 13/701,152

(22) PCT Filed: May 31, 2011
(86) PCT No.: PCT/EP2011/058919

§ 371 Date: Feb. 6, 2013

(30) Foreign Application Priority Data
May 31, 2010 (DE) 10 2010 022 597.5

(51) Int. Cl. B05D 1/12

(52) U.S. Cl. CPC B05D 1/12
USPC 427/192

(57) ABSTRACT

The invention relates to a method for generating an abrasive wear-resistant layer (13) on a substrate (11). According to the invention, said layer (13) consists of particles (14) of a ductile material, in particular Zn, wherein the parameters of the cold spraying process are set such that a comparatively loose laminate having pores (15) is formed by the spray particles (14). Said laminate advantageously and surprisingly exhibits high resistance to abrasive wear (for example by a particle (16)) because the layer (13) can avoid the attack by the particle (16) by plastic deformation and closure of the pores (15), whereby abrasive removal of the layer is advantageously low. The invention further relates to a use of a cold gas-sprayed layer as a protective layer against abrasive wear.

The invention relates to a method for generating a layer that is resistant to abrasive wear, for example particle erosion, on a workpiece by cold gas spraying. In the case of this method, particles are accelerated toward the surface of the substrate to be coated and remain adhering to the substrate at the point of impingement. In this way, a cold-gas-sprayed layer is created, the invention also relating to a use of such a porous layer. Preferably used for the cold gas spraying, which is also referred to as kinetic spraying, is a cold gas spraying installation, which has a gas heating device for heating a gas. Connected to the gas heating device is a stagnation chamber, which is connected on the outlet side to a convergent-divergent nozzle, preferably a Laval nozzle. Convergent-divergent nozzles have a converging portion and a diverging portion, which are connected by a nozzle neck. The convergent-divergent nozzle generates on the outlet side a particle jet in the form of a gas stream containing particles traveling at high speed, so that the kinetic energy of the particles is sufficient for them to remain adhering on the surface to be coated.

The production of a layer that is resistant to abrasive wear is described, for example, by R. S. Lima et al., “Microstructural Characteristics of Cold-Sprayed Nanostructured WC—Co Coatings”, Thin Solid Films 416 (2002), pages 129-135. The layer described there has a fine microstructure, which is referred to as a nanostructured WC—Co coating.

This can be deposited on a substrate by cold gas spraying, a high degree of hardness, and consequently a high resistance to abrasive wear, being obtained because of the WC component of the microstructure.

However, the wearing of a hard layer such as this is primarily dependent on how hard the particles in the abrasive medium are. If the abrasive medium itself has a hardness similar to WC, comparatively high abrasive wear can likewise be found when wear-resistant layers containing WC are used.

The object of the invention is to provide a method for generating a layer resistant to abrasive wear by which layers that have a comparatively high abrasive wear resistance can be generated.

This object is achieved according to the invention by the method mentioned at the beginning, in that the particles consist of Zn and/or Sn and/or Cu and/or Al and/or Ti and/or an alloy containing at least one of these metals as a main constituent. Furthermore, the speed of the particles impinging on the substrate is set such that the layer formed by these particles is porous and the grain size of the layer structure corresponds substantially to the particle size. Consequently, the pores that form in the microstructure of the layer lie exactly between the particles, while the particles are largely preserved in their form by setting the process parameters during the cold gas spraying. The comparatively high porosity of the coating result has the effect of creating as it were a loose metal structure, the selected metals exhibiting a ductile behavior. If the resistant layer is subsequently exposed to particle erosion for example, there is initially a plastic deformation of the particles in the layer, which, though leading to a consolidation of the microstructure and a reduction in its porosity, ensures that only little material is removed from the layer as result of the attack by the abrasive particles. The exposure of the resistant layer to the action of the particles can therefore be referred to as a kind of micro-forging, the plastic deformation of the particles in the microstructure of the resistant layer having the effect that material removal is largely avoided.

Herein there lies a surprising effect, which underlies the porous layer produced according to the invention with a high ductility. Instead of providing a wear-resistant layer with as high a hardness as possible, as specified by R. S. Lima et al., according to the present invention an opposite approach is taken, specifically that of designing the resistant layer in such a way that exposure to the action of an abrasive medium allows the deformation of the layer, in order to prevent abrasive wear of this layer by plastic yielding of the layer particles concerned.

According to an advantageous refinement of the invention, it is provided that the particles have an average particle size of 1 to 10 μm, preferably 2 to 5 μm. For the purposes of the invention, particle size should be understood as meaning the average diameter of the particles, which can be statistically determined by known methods. Particles that are not round also have such an average diameter, and so their particle size can be specified. The choice of relatively fine particles advantageously leads to a microporosity of the layer, so that these particles can withstand particle erosion particularly effectively by plastic deformation of the porous particle composite on the basis of the mechanism described above.

According to another refinement of the invention, it is provided that, before the layer is applied, an adhesion promoting layer, in particular a layer of Ni, is applied to the substrate, having the effect of fixing the layer by forming common diffusion zones or intermetallic phases. This advantageously allows the adhesive bonding of the layer on the substrate to be improved by the formation of diffusion zones or intermetallic phases, in order that the exposure to the action of the abrasive medium does not lead to delamination of the layer. This measure also makes it possible in particular to applying the resistant layer to substrates that in themselves form a poor base for the metals selected. The resistant layer can then be deposited with good bonding on the adhesion promoting layer, which itself adheres well on the substrate.

Furthermore, the object specified at the beginning is achieved by a porous cold-gas-sprayed layer, which consists of Zn and/or Sn and/or Cu and/or Al and/or Ti and/or an alloy containing at least one of these metals as a main constituent, being used as a protective layer on a workpiece to be protected from abrasive wear, pores being located between the cold-gas-sprayed particles. Such a use therefore involves the layer being produced on the workpiece concerned by cold gas spraying. By using the cold-gas-sprayed layer as specified by the invention, the advantages already mentioned above are achieved. As already mentioned, this involves taking the approach that a comparatively soft, ductile layer is used as the layer resistant to abrasive wear and not a hard wear-resistant layer, making use of the surprising effect that a soft, ductile layer can yield by plastic deformation to evade the attack by the abrasive medium, for which reason removal of material is advantageously reduced.

According to a refinement of the invention, it is provided that the workpiece consists of a metal or a metal alloy that is nobler than the material of the particles. In other words, the metal or the metal alloy of the workpiece should have a greater standard hydrogen electrode potential in the electrochemical voltage series than the material that constitutes the particles. This advantageously achieves the effect that the layer according to the invention at the same time represents what is known as a cathodic corrosion protection for the substrate. Even if the layer is removed completely at some points of the workpiece by the advancing abrasive wear, the damaged layer still ensures corrosion protection since it then acts as a sacrificial anode. In other words, electrochemical attack on the workpiece is prevented by the less noble metal of the layer dissolving, whereby the material of the workpiece is protected.

Further details of the invention are described below on the basis of the drawing. The same or corresponding elements of the drawing are respectively provided with the same designations in individual figures and are only explained more than once to the extent that there are differences between individual figures, in which:

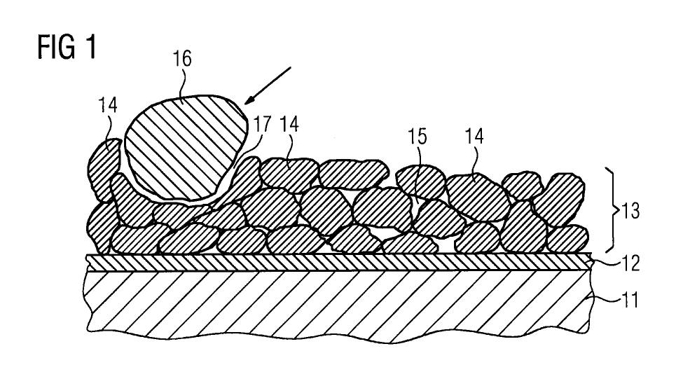

FIG. 1 shows a schematic section through an exemplary embodiment of the layer according to the invention and

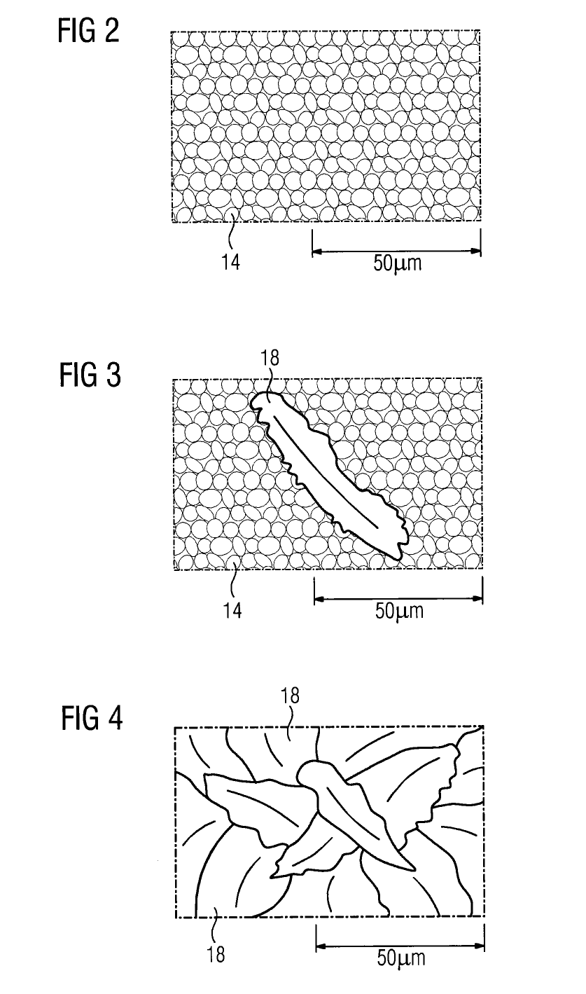

FIGS. 2 to 7 show plan views of the surface of an exemplary embodiment of the layer according to the invention; the various stages of wear of the surface represent particle erosion, respectively in a schematic form and in the form of photos.

On the basis of FIG. 1, the method steps of an exemplary embodiment of the method according to the invention can be presented. On a workpiece 11, an adhesion promoting layer 12, which consists of nickel, has first been applied by means of cold gas spraying. Alternatively, this layer could also be applied electrochemically. In a further step, a resistant layer 13, which consists of particles 14, is applied by cold gas spraying. These particles can still be clearly seen in their contour in the section according to FIG. 1, since the parameters of the cold gas spraying are set such that the particles 14 are scarcely deformed when they impinge on the workpiece 11 (substrate). However, the kinetic energy input into the particles is sufficient for them to remain adhering on the adhesion promoting layer 12 or on neighboring particles 14. Between the particles there form pores 15, which lead to a loose layer structure.

FIG. 1 also schematically depicts the mechanism of how the layer 13 responds to exposure to the action of an abrasive particle 16. The abrasive particle plastically deforms the particles 14 on which it acts, the pores between these particles at the same time being closed. This leaves a depression 17 in the form of a crater or scratch, although it does not have the effect that the material of the layer is removed, or only scarcely, but rather that it yields to the action of the abrasive particle 16 while undergoing plastic deformation.

Using what is known as an HZO paint zinc dust, superfine, from the company Norzinco GmbH, with particle sizes of between 2 and 5 μm, a resistant layer was produced by cold gas spraying. The surface produced can be seen in FIG. 2 or 5. The particles 14 can still be seen on the surface, with pores between the particles also being discernible.

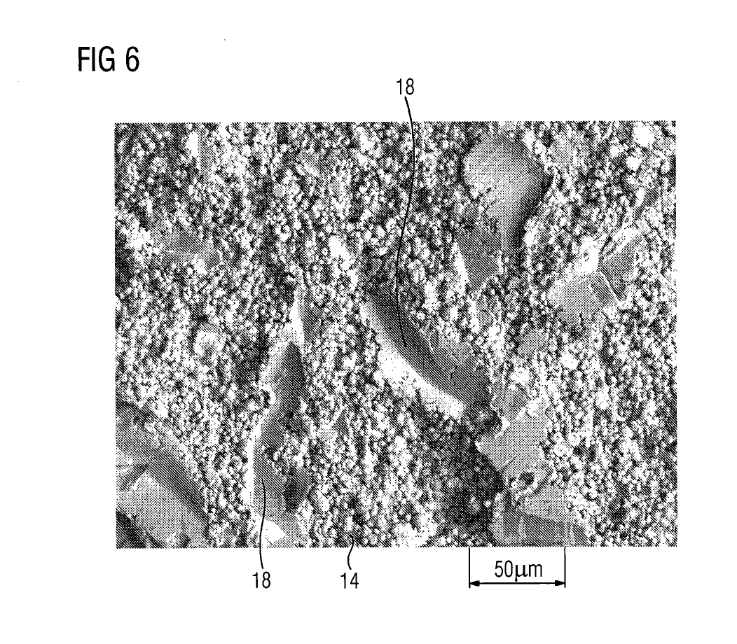

The layer surface generated was treated by sand blasting, using corundum with an average particle size of 120 μm. As can be seen from FIGS. 3 and 6, the first corundum particles 16, which graze the surface, cause scratches 18, which generate depressions 17, such as those schematically represented in FIG. 1.

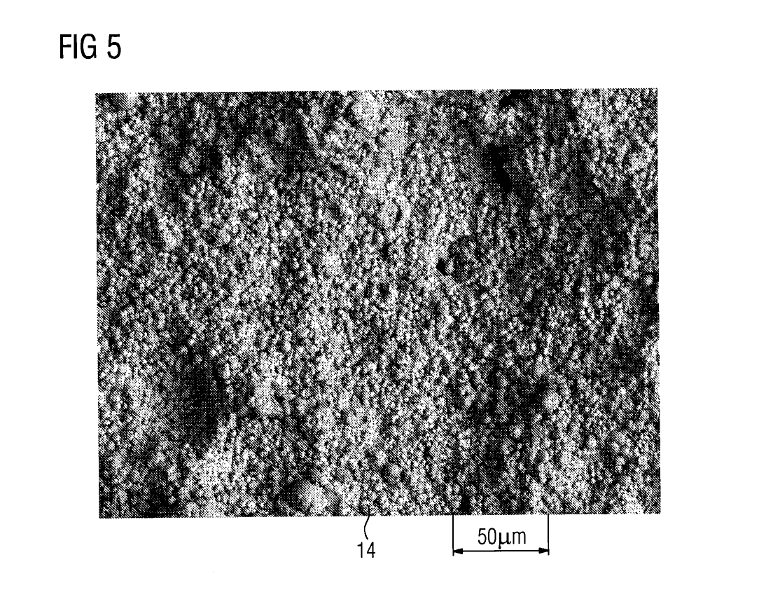

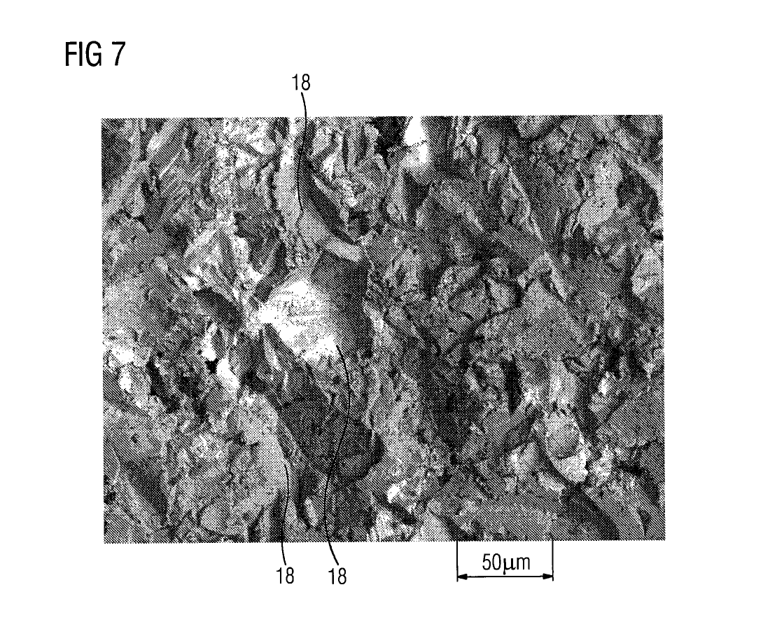

If the surface is exposed to sand blasting over a prolonged period of time, a surface image according to FIG. 4 or 7 is obtained. It is clear that the various scratches 18 that are generated by the corundum particles 16 overlay and overlap one another. It is clear from this that multiple plastic deformation of the material of the layer is also possible, even if the surface, consisting of particles 14, is no longer recognizable in its original state after prolonged attack by the abrasive medium. Nevertheless, even in this stage of exposure, the abrasive removal of zinc is still relatively low.

1. A method for generating a layer (13) that is resistant to abrasive wear on a workpiece (11) used as a substrate by cold gas spraying, in which particles (14) are accelerated toward the surface of the substrate to be coated and remain adhering to the substrate at the point of impingement,
characterized
in that the particles (14)
consist of Zn and/or Sn and/or Cu and/or Al and/or Ti and/or an alloy containing at least one of these metals as a main constituent, and
impinge on the substrate at a speed such that the layer forming is porous and the grain size of the layer structure corresponds substantially to the particle size.

2-6. (canceled)
